(19) United States
(12) Patent Application Publication
(10) Pub. No.: US 2002/0117361 A1
(43) Pub. Date: Aug. 29, 2002

(54) Disk brake for vehicles and method of making same

(76) Inventors: Rolf von Sivers, Weissach-Flacht (DE); Claus Thomas, Remseck (DE)

Correspondence Address: CROWELL & MORING, L.L.P., P.O. Box 14300, Washington, DC, 20044-4300, US

(21) Appl. No.: 10/071,194

(22) Filed: Feb. 11, 2002

(30) Foreign Application Priority Data
Feb. 10, 2001 (DE) DE 101 06 177.3

(51) Int. Cl. F16D 55/18

(52) U.S. Cl. 188/72.4

(57) ABSTRACT

A disk brake comprises a brake disk and a caliper which carries lining devices having lining surfaces, the brake disk having concave brake disk surfaces on the sides facing the lining surfaces, which brake disk surfaces interact with the convexly constructed lining surfaces. To minimize the potential for generation of noise by the disk brake, the brake disk having concave brake disk surfaces has a multi-part construction, the brake disk is provided with a groove-type recess at least on one of the two brake disk surfaces, and/or the lining devices comprise lining bodies with a high-performance lining mixture.

### BACKGROUND AND SUMMARY OF THE INVENTION

This application claims the priority of German Patent Document DE 101 06 177.3, filed on Feb. 10, 2001, the disclosure of which is expressly incorporated by reference herein.

The invention relates to a disk brake for vehicles, particularly motor vehicles, having a brake disk and a caliper which carries lining devices having lining surfaces, the brake disk having concave brake disk surfaces on sides facing the lining surfaces, said brake disk surfaces interacting with the convexly constructed lining surfaces.

For avoiding an uneven wear of brake disks of a disk brake, it is known from German Patent Document DE 43 36 094 A1 to enlarge a brake disk by contouring. In one embodiment of that document, the brake disk is concavely curved. This construction has the disadvantage that disturbing noise emissions occur when the disk brake operates at a low system pressure, for example, when starting and stopping in city traffic.

In German Patent Document DE 198 37 166 A1, and corresponding U.S. Pat. No. 6,241,054, a disk brake is shown which is suitable for installation into a motor vehicle and has a brake disk which is provided with spaced concave brake disk surfaces. Convex lining surfaces of lining bodies interact with the concave brake disk surfaces, which lining bodies and the lining supports form lining devices. Each lining body is connected with a flat supporting surface of the pertaining lining support. As a result of the concave brake disk surfaces and the convex lining surfaces, which interact with a defined form closure, disturbing noises, for example, during coasting braking—at pedestrian crossovers, traffic lights—are clearly reduced.

In an aspect of certain preferred embodiments of the invention, measures at the disk brake with the concave brake disk surface and the convex lining surfaces are taken so that the potentials for generating noise during defined driving and braking conditions are minimized.

According to certain preferred embodiments of the invention, this object is achieved in that the brake disk having the concave brake disk surfaces has a multi-part construction, wherein the brake disk is provided with a groove recess at least on one of the brake disk surfaces, and wherein the lining devices comprise lining bodies with a high-performance lining mixture. Additional characteristics which further develop and optimize the invention are contained in other preferred embodiments.

The principal advantages achieved by way of certain preferred embodiments of the invention are that the disk brake, which comprises concave brake disk surfaces and convex lining surfaces causing a defined form closure, is optimized by one or several measures with respect to lower noise emissions or noise emissions without any disturbing effect. For this purpose, the following was found to be advantageous in tests. The brake disk is constructed in several parts. The brake linings comprise lining bodies with a high-performance lining mixture. The brake disk is provided with a groove-type recess at least at one brake disk surface. At least one canceling device is provided at the caliper. At least one damping element is arranged on the lining devices. Finally, the brake disk may be made of ceramics, gray cast iron or of an alloy of aluminum and gray cast iron. These measures can be implemented by way of constructively presentable and acceptable devices.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a main view of a disk brake;

FIG. 2 shows a sectional view according to line II-II of FIG. 1;

FIG. 3 shows a sectional view according to line III-III of FIG. 1;

FIG. 4 shows a sectional view according to line IV-IV of FIG. 2; and

FIG. 5 shows a diagram of the influence of certain measures for the generation of noise by a disk brake.

### DETAILED DESCRIPTION OF THE DRAWINGS

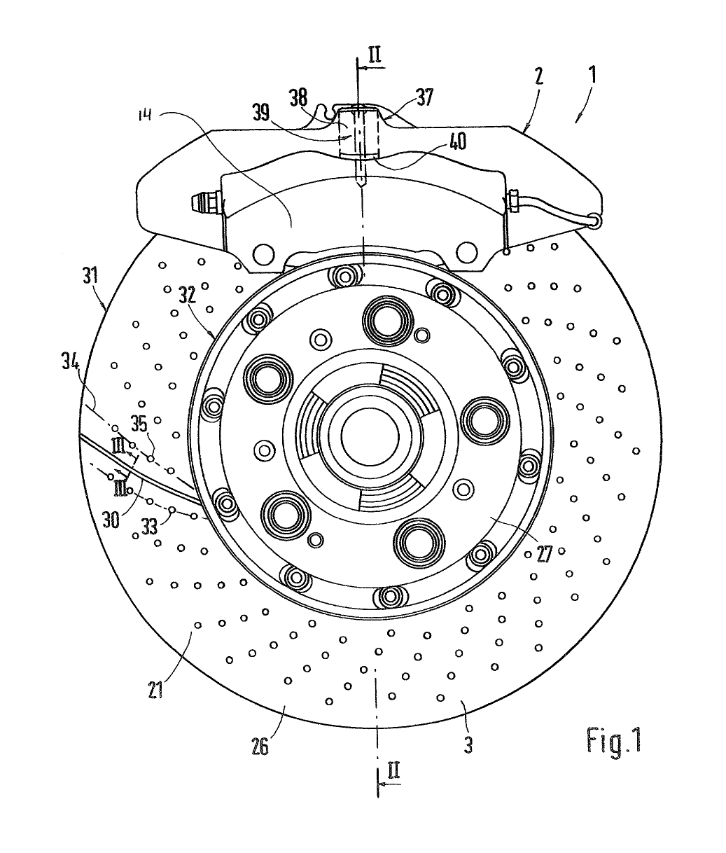

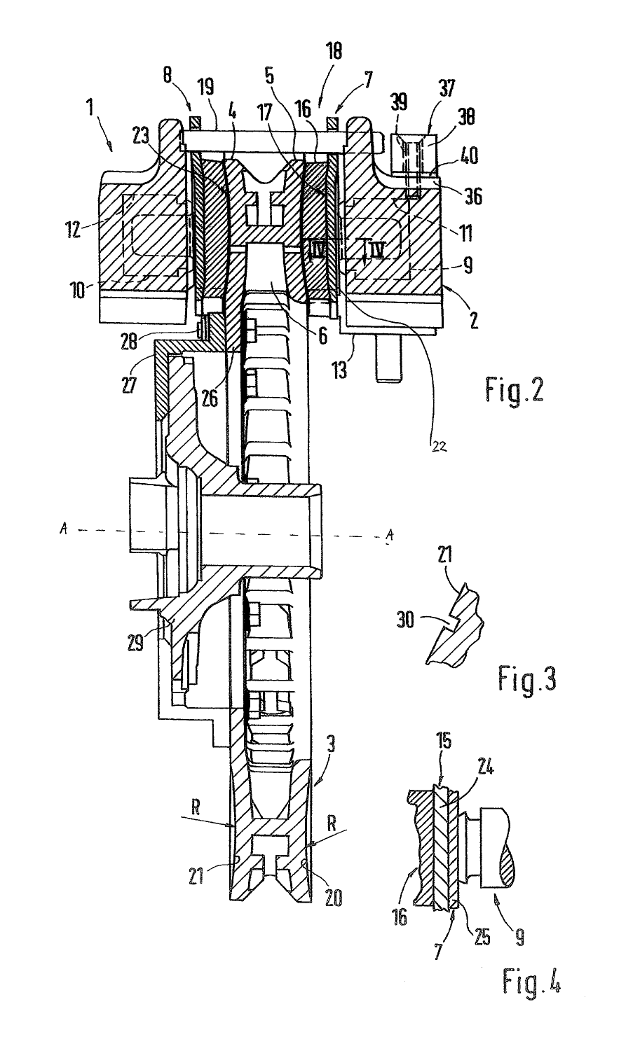

A disk brake 1, which may be installed, for example, into a road vehicle, a rail vehicle, an airplane or the like, comprises a caliper 2 and a brake disk 3 with opposite friction ring halves 4, 5 which bound a cooling duct 6, as shown in FIGS. 1 and 2.

The caliper 2 is constructed as a so-called fixed caliper which has lining devices 7, 8 floatingly disposed on both sides of the brake disk. These lining devices 7, 8 can be acted upon by way of pistons 9, 10 which act in the axial direction A-A of the brake disk 3. The pistons 9, 10 are axially movably disposed in bores 11, 12 of caliper housings 13, 14. Each lining device, for example, 7, comprises a lining support 15 and a lining body 16 which are fixedly connected with one another on a supporting surface 17 of the lining support 15. The lining support 15 is provided with a bore 18 which surrounds a bolt 19 extending between the caliper housings 13, 14. The lining device 7 can be displaced on the bolt 19, specifically in its axial direction.

On the side facing the lining devices 7, 8, that is, on the friction ring halves 4, 5, the brake disk 3 has concave brake disk surfaces 20, 21, the concavity of the brake disk surfaces 20, 21 being determined by a radius R. The lining devices 7, 8 are provided with lining surfaces 22, 23 which have a convex construction and interact with the brake disk surfaces 20, 21. The convexity is determined by the radius R.

The lining support 15—FIG. 4—is constructed in the manner of a plate which extends in the radial direction of the brake disk 3 and, in addition to the supporting surface 17, has a rear side 24. The supporting surface 17 and the rear side 24 are arranged at a parallel distance from one another, the rear side 24 interacting with the piston 9 of the caliper housing 13. Between the piston 9 and the rear side 24, a damping element 25 is provided which is constructed in the manner of a plate and is connected with the lining support 15.

The brake disk 3, which may consist of ceramics, of gray cast iron or of an alloy of aluminum and gray cast iron, is constructed in several parts. For this purpose, a ring part 26, which comprises the friction ring halves 4, 5, is connected with a center part 27 by way of screws 28. The center part 27 has a pot which is designed for accommodating a wheel hub 29. Details of a multi-part brake disk, particularly with respect to vibration-damping screwed connections between the ring part 26 and the center part 27 are described in German Patent Document DE 44 46 017 C2.

A groove-type recess 30 is worked into at least one brake disk surface 21 of the brake disk 3, which recess 30 has an involute-type course on this brake disk surface 21 between an outer circular boundary 31 and an inner circular boundary 32. According to FIG. 3, the cross-section of the recess 30 is U-shaped or channel shaped. However, it may also be triangular or in the shape of a segment of a circle. In addition, the above-mentioned recess 30 extends between two rows 33 and 34 of axial bores 35 extending in the manner of involutes, with which the brake disk surface 20 is provided.

The lining bodies 16 of the lining devices 7, 8 are made of a high-performance lining mixture which, although it is stable with respect to temperature, is wear-resisting and does not fade, and which develops a noise-bearing behavior based on these characteristics.

In FIG. 2, a canceling device 37 is mounted on a step 36 of the caliper housing 13, which canceling device 37 is formed by a mass body 38 made of a ferrous-metal material and is held in position by way of one or several screws 39 at the caliper housing 13, specifically by way of an elastic element 40.

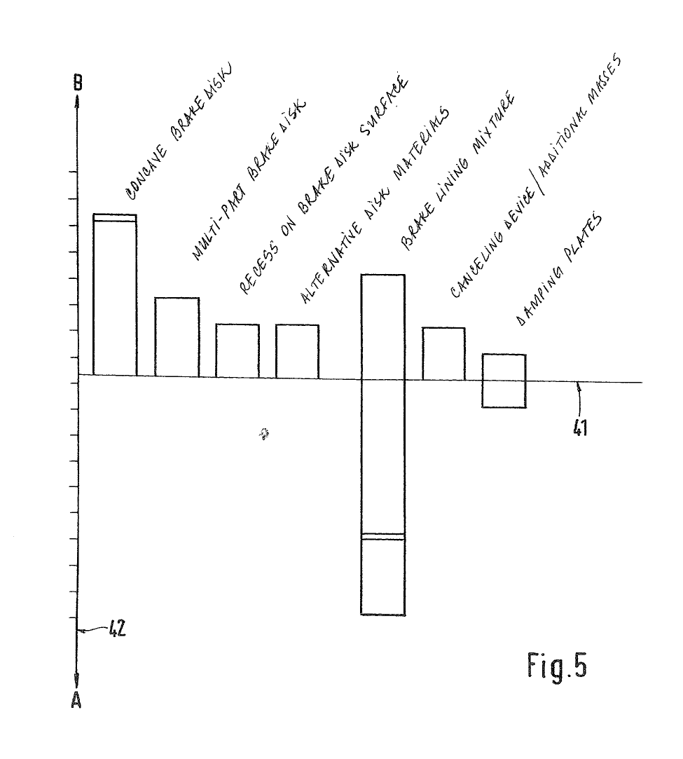

The diagram according to FIG. 5 reflects measures for influencing the generation of noise by the disk brake 3. In this case, the abscissa axis 41 represents a given reference level, and bars are entered along the abscissa axis 41 which demonstrate the effect of the individual measures—concave brake disk, multi-part brake disk, recess on the brake disk surface, alternative material of the brake disk, among others, ceramics; lining devices with a high-performance lining mixture; canceling devices and damping element. On the ordinate axis 42 of the diagram, the noise sensitivity is indicated. In this case, the probability that noises occur is indicated below the abscissa axis 41 in the direction A. The probability that no noises occur is indicated above the abscissa axis 41 in the direction B. This demonstrates that, on the one hand, the concave brake disks in combination with the convex lining surfaces—already make a significant contribution to the reduction of noise and, on the other hand, that the high-performance lining mixture of the lining devices, which has a relatively high probability of generating noise, leads either only together with the concave brake disks and/or with additional measures individually or combined to the endeavored goal, that is, a low-noise operation of the disk brake, specifically during coasting braking.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A disk brake for vehicles, comprising a brake disk and a caliper which carries lining devices having lining surfaces, the brake disk having concave brake disk surfaces on sides facing the lining surfaces, said brake disk surfaces interacting with the convexly constructed lining surfaces,
wherein the brake disk having the concave brake disk surfaces has a multi-part construction,
wherein the brake disk is provided with a groove recess at least on one of the brake disk surfaces, and
wherein the lining devices comprise lining bodies with a high-performance lining mixture.

2. A disk brake according to claim 1, wherein the multi-part brake disk comprises a ring part which is connected with a center part by way of screws.

3. A disk brake according to claim 1, wherein the groove recess has an involute course on the brake disk surface.

4. A disk brake according to claim 3, wherein the recess extends between two rows of axial bores being arranged involute in the brake disk surface.

5. A disk brake according to claim 1, wherein the high-performance lining mixture is stable with respect to temperature, is wear-resistant and does not fade.

6. A disk brake having caliper housings arranged on both sides of a brake disk, in said caliper housings, pistons being disposed which interact with lining devices, each of the lining devices comprising a lining support and a lining body, said lining support interacting with the adjacent piston, whereby concave piston surfaces operatively interact with convex lining support surfaces,
wherein the brake disk having the concave brake disk surfaces has a multi-part construction,
wherein the brake disk is provided with a groove recess at least on one of the brake disk surfaces,
wherein the lining devices comprise lining bodies with a high-performance lining mixture, and
wherein at least one canceling device is mounted on the caliper, and a damping element is mounted on at least one of the lining devices.

7. A disk brake according to claim 6, wherein the canceling device is mounted on a caliper housing.

8. A disk brace according to claim 6, wherein the damping element is mounted on a side of the lining support facing the piston.

9. A disk brake according to claim 6, wherein the canceling device is a mass body.

10. A disk brake according to claim 9, wherein the mass body is made of a ferrous-metal material which is held on the caliper by an elastic element

11. A disk brake according to claim 9, wherein the damping element is formed by a plate which is connected with the lining support.

12. A disk brake for vehicles, comprising:
a brake disk and a caliper which carries lining devices having lining surfaces, the brake disk having concave brake disk surfaces on sides facing the lining surfaces, said brake disk surfaces interacting with the convexly constructed lining surfaces,
wherein the disk brake is provided with at least one of
the lining devices comprising lining bodies with a high-performance lining mixture,
the brake disk with said concave brake disk surfaces having a multi-part construction,
the brake disk being provided with a groove recess at least on one of the brake disk surfaces,
at least one canceling device being provided on the caliper, and at least one damping element being arranged on the lining devices, and
the brake disk being made of ceramics, gray cast iron or of an alloy of aluminum, gray cast iron or equivalents thereof.

13. A disk brake for vehicles, comprising:
a caliper carrying lining devices with convex lining surfaces, and
a brake disk having concave brake disk surfaces on sides facing the lining surfaces, said brake disk surfaces being arranged to operatively interact with the lining surfaces,
wherein the brake disk is of multi-part construction and is provided with a groove recess at least on one of the brake disk surfaces, and
wherein the lining devices comprise lining bodies with a high-performance lining mixture.

14. A disk brake according to claim 13, wherein the groove recess has an involute course.

15. A method of making a disk brake for vehicles, comprising:
providing a caliper which carries lining devices with convex lining surfaces,
arranging concave brake disk surfaces of a multi-part construction brake disk to face the lining surfaces, said brake disk surfaces being adapted to operatively interact with said lining surfaces, and
locating a groove recess on at least one of the brake disk surfaces,
wherein the lining devices comprise lining bodies with a high-performance lining mixture.

16. A method according to claim 15, wherein the multi-part brake disk comprises a ring part which is connected with a center part by way of screws.

17. A method according to claim 15, wherein the groove recess has an involute course on the brake disk surface.

18. A brake for vehicles, comprising:
a brake disk of multi-part construction having concave surfaces,
a caliper carrying lining devices with convex lining surfaces facing and interacting with the concave surfaces, and
a groove recess being arranged on at least one of the brake disk surfaces,
wherein the lining devices include lining bodies with a high-performance lining mixture.
